(19) United States
(12) Patent Application Publication
(10) Pub. No.: US 2006/0216493 A1
(43) Pub. Date: Sep. 28, 2006

(54) Nano porous and pliable polymer flexible article

(75) Inventor: Hsi-Chen Li, Fongyuan City (TW)

Correspondence Address: TROXELL LAW OFFICE PLLC, SUITE 1404, 5205 LEESBURG PIKE, FALLS CHURCH, VA, 22041, US

(73) Assignee: Hua Ying Chin Nanotechnology Co., Ltd.

(21) Appl. No.: 11/117,367

(22) Filed: Apr. 29, 2005

(30) Foreign Application Priority Data
Mar. 28, 2005 (TW) 094204745

(51) Int. Cl. B32B 5/22

(52) U.S. Cl. 428/317.9; 428/315.5

(57) ABSTRACT

A nano porous and pliable polymer flexible article, including a flexible compound body having a plurality of irregular and breathable pores disposed thereon wherein the flexible compound body is made up of a finely powdered and pliable compound mutually mixed with a nano-powderized and porous mineral clay to form a polymerized compound that is further squeezed via a set of double shafts to provide a plurality of granulated particles before a cross-linking agent and a medium-temperature foaming agent in a relatively appropriate proportion are respectively combined with the granulated particles thereof, and, via chemical foaming process thereof, the granulated particles will be transformed and shaped into a sheet of nano porous and pliable polymer flexible article with a plurality of pores disposed thereon. Via the aforementioned structure, the nano porous and pliable polymer flexible article obtained thereby can be further processed via thermo-pressurized operation into various products in application thereof. Via the multiple pores thereof, the polymer flexible article thereof can achieve better ventilating effect to avoid the uncomfortable feeling of stuffiness and humidity to a user thereof, facilitating more comfortable and widespread application of the present invention thereof.

### BACKGROUND OF THE INVENTION

The present invention is related to a nano porous and pliable polymer flexible article, including a flexible compound body having a plurality of irregular and breathable pores disposed thereon wherein the flexible compound body is made up of a finely powdered and pliable compound molded with a nano-powderized and porous mineral clay and squeezed via double shafts into a plurality of granulated particles that is further mixed with a cross-linking agent and a medium-temperature foaming agent and, via chemical foaming process, shaped into a sheet of nano porous and pliable polymer flexible article with breathable pores disposed thereon, which can secondly processed via thermo-pressurized operation into various products and, via the multiple pores thereof, can provide better ventilating effect so as to achieve more comfortable and widespread application thereof.

Please refer to FIG. 1. A conventional base material applied for products requiring the properties of softness and flexibility such as leisure/sport shoes, safety products, toys, medical rehabilitation equipments, and shoes pads, etc. as shown in FIG. 1 is usually made up of synthetic rubber like EPDM and EVA that are mutually mixed and foamed before further processed into the finished products thereof. However, the finished products obtained thereby are equipped with limited effects of softness and flexibility thereof, and are unable to resist high/lower temperature, pressure, and pulling force applied thereto. Besides, without breathable pores disposed thereon, the above-mentioned conventional products feature a bad ventilation effect in application, which can reduce their lifetime and makes them easily get deformed and deteriorated in application.

### SUMMARY OF THE PRESENT INVENTION

It is, therefore, the primary purpose of the present invention to provide a nano porous and pliable polymer flexible article, including a flexible compound body having a plurality of irregular and breathable pores disposed thereon wherein the flexible compound body can be further processed into various products, and, via the multiple pores thereof, the finished products obtained thereby can provide better ventilating effect to avoid the disadvantages of stuffiness and humidity of the abovementioned conventional products thereof, effectively achieving more comfortable and widespread application thereof

### BRIEF DESCRIPTION OF THE DRAWINGS

FIG. 1 is a cross sectional view of a conventional synthetic rubber article.

FIG. 2 is a diagram showing the process in the molding of the present invention.

FIG. 3 is a perspective view of the present invention.

FIG. 4 is a partially cross sectional view of the present invention.

FIG. 5 is a diagram showing an embodiment of the present invention in application.

FIG. 6 is a diagram showing another embodiment of the present invention in application.

FIG. 7 is a diagram showing a third embodiment of the present invention in application.

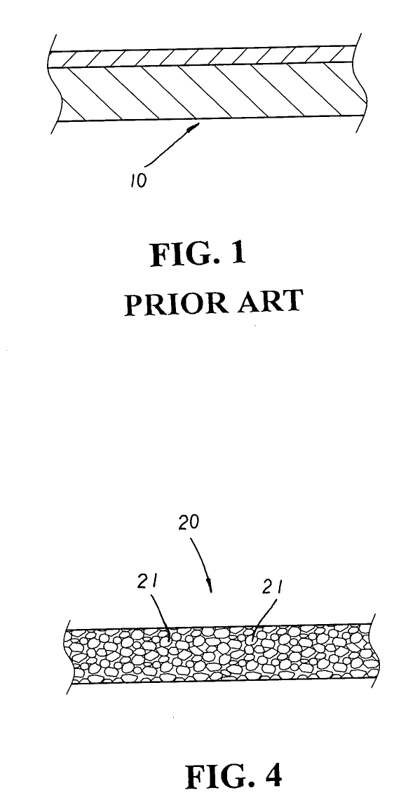

### DETAILED DESCRIPTION OF THE PREFERRED EMBODIMENTS

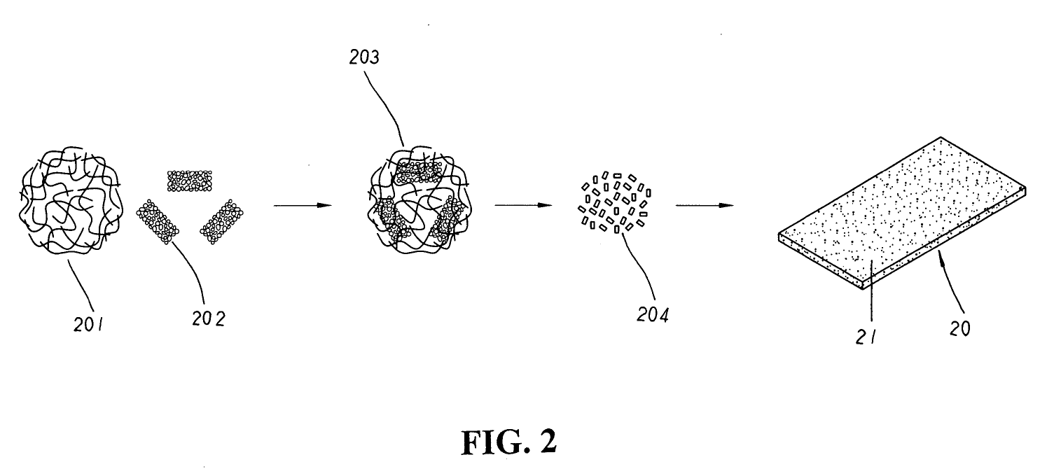

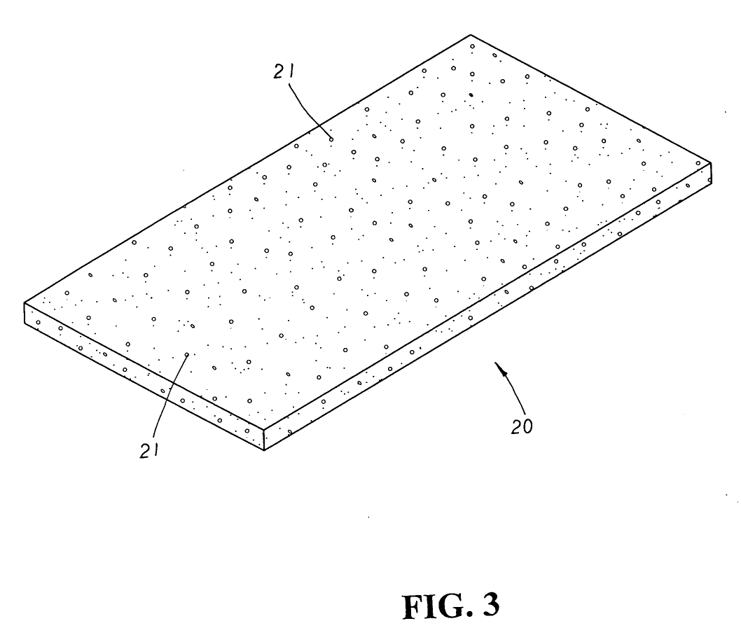

Please refer to FIGS. 2 to 3 inclusive. The present invention is related to a nano porous and pliable polymer flexible article, including a flexible compound body 20 having a plurality of irregular and breathable pores 21 disposed thereon wherein the flexible compound body 20 is made up of a finely powdered and pliable compound (HYC-68D₂) 201 mutually mixed and molded with a nano-powderized and porous mineral clay 202 to form a polymerized compound 203 that is further squeezed via a set of double shafts to provide a plurality of granulated particles 204. Then, a cross-linking agent and a medium-temperature foaming agent in a relatively appropriate proportion are respectively combined with the granulated particles 204 that, via chemical foaming process thereof, will be transformed and shaped into a sheet of nano porous and flexible compound body 20 with a plurality of pores 21 disposed thereon as shown in FIG. 4, which can serve as a base material and is benefited with a range of properties, including resistance to high/low temperature, long durability, anti-slippery, light in relative density, and pliability as well as shock-absorption, and good-ventilation thereof.

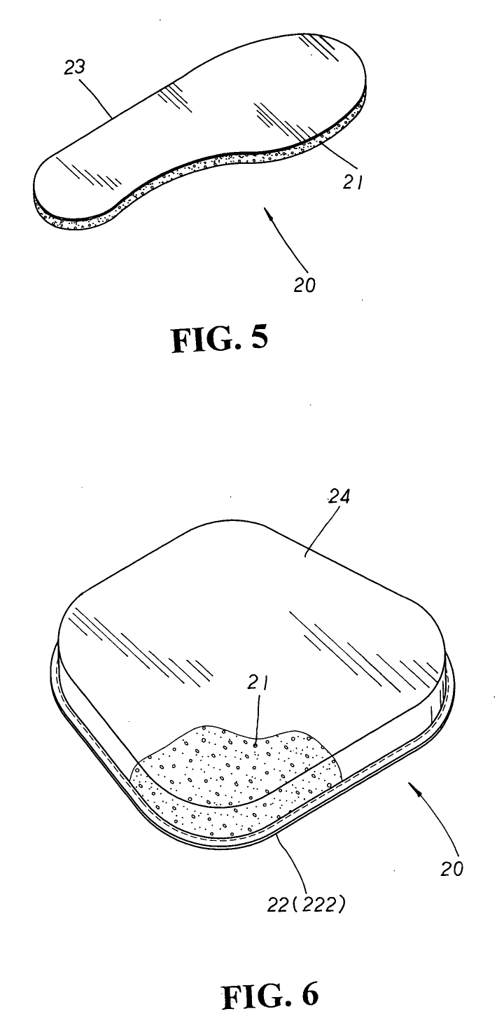

Please refer to FIG. 5. The flexible compound body 20 thereof as a base material thereof can be further processed via thermo-pressurized operation and molded into various products for use such as a pad body 22 (like a shoe pad 221) onto the outer surface of which can be attached a sheet of non-woven fabric 23 as shown in FIG. 5. Via the multiple pores 21 thereof, the shoe pad 221 made of the flexible compound body 20 thereof can achieve better ventilating effect to avoid the uncomfortable feeling of stuffiness and humidity to a wearer in application thereof. And, via better flexibility thereof, the shoe pad 221 thereof can also effectively release and soothe the pressure when stepped thereon to provide more comfortable and easier walking thereby. Therefore, the flexible compound body 20 can be variously applied to a range of products requiring comfortable feeling and high flexibility such as leisure/sport shoes, safety supplies, toys, and medical rehabilitation equipments, etc., effectively achieving widespread application thereof.

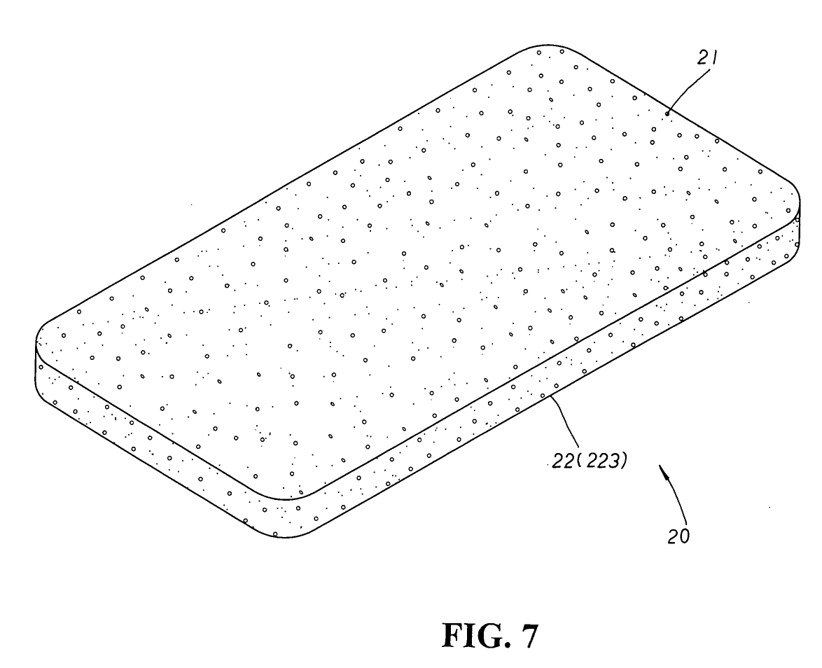

Please refer to FIG. 6 showing a second embodiment of the present invention. The pad body 22 processed from the flexible compound body 20 as a base material thereof can also be made into a seat cushion 222, or a yoga mattress 223 as shown in FIG. 7. The seat cushion 222 having a wrapping layer 24 bound at the outer surface thereon can achieve excellent softness via the pad body 22 wrapped therein and better ventilating effect via the multiple pores 21 disposed at the pad body 22 thereon so that a user can comfortably sit, stretch, or lie thereon. Besides, the pad body 22 can also be economically recycled to effectively achieve environmental protection. And in case the pad body 22 is stained by liquid accidentally splashed onto the surface thereof, the pores 21 thereof can quickly disperse and evenly absorb the splashed liquid to avoid the direct infiltration of the liquid therein, facilitating more convenient and multi-functional application of the present invention.

1-2. (canceled)

3. A nano porous and pliable polymer flexible article comprising:
a flexible compound body having a plurality of irregular and breathable pores, the flexible compound body is made of a finely powdered and pliable compound mutually mixed and molded with a nano-powderized and porous mineral clay to form a polymerized compound that is further squeezed via a set of double shafts to provide a plurality of granulated particles before a cross-linking agent and a medium-temperature foaming agent in a relatively appropriate proportion are respectively combined with the granulated particles thereof, and via a chemical foaming process, the granulated particles thereof will be transformed and shaped into the flexible compound body with the plurality of pores.

4. The nano porous and pliable polymer flexible article according to claim 3, wherein the flexible compound body is a base material to be further processed into a product selected from a group consisting of shoe pads, seat cushions, and yoga mattresses.

5. The nano porous and pliable polymer flexible article according to claim 3, wherein the flexible compound body is formed into a completed product utilizing a thermo-pressurized operation.
